(19) United States
(12) Patent Application Publication
(10) Pub. No.: US 2010/0273489 A1
(43) Pub. Date: Oct. 28, 2010

(54) Method for Reselections in the Presence of Femto Cells

(75) Inventor: Murali Narasimha, Lake Zurich, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., Schaumburg, IL (US)

(21) Appl. No.: 12/767,486

(22) Filed: Apr. 26, 2010

Related U.S. Application Data
(60) Provisional application No. 61/173,084, filed on Apr. 27, 2009.

(51) Int. Cl. H04W 36/00

(52) U.S. Cl. 455/436

(57) ABSTRACT

A method for performing cell reselection in a cellular communication network including determining a first receive power and a first pathloss of a signal from a first cell, determining a second receive power and an upper bound on a second pathloss of a signal from a second cell, and selecting the second cell when the difference between the first path loss and the upper bound on the second path loss is greater than a first threshold and the difference between the first receive power and the second receive power is smaller than a second threshold.

### CROSS REFERENCE TO RELATED APPLICATIONS

The present application is a non-provisional application of co-pending U.S. Provisional Application No. 61/173,084 filed on 27 Apr. 2009, the contents of which are hereby incorporated by reference and from which benefits are claimed under 35 U.S.C. 119.

### FIELD OF THE DISCLOSURE

The present disclosure relates generally to wireless communications and, more specifically, to cell selection and reselection in a wireless communication system having macro and femto cells.

### BACKGROUND

Idle mode reselection between cells is based on the “best cell” principle. A UE selects the cell with the best receive power, e.g., reference signal receive power (RSRP). A femto cells has much lower transmit power levels compared to a macro cell. This implies that when a UE is close to a femto cell that the UE is allowed to access, the UE may select a macro cell on the same carrier frequency due to the RSRP of the macro cell being higher. This has the following implications: Attaching to the macro cell when close to a femto cell can lead to significant uplink (UL) interference to the femto cell. Operators generally try to provide a higher level of service to the user through femto cells (e.g., hybrid access femto cells). A UE attaching to a macro cell as described above makes this difficult in two ways: the particular UE cannot be provided the higher level of service, and the UE's transmissions can degrade the level of service in the femto cell. Femto cell deployment is a mechanism to increase network capacity, i.e., the same frequency resources are spatially reused. UEs that select a macro cell when a femto cell is accessible make spatial frequency reuse difficult. Therefore, better mechanisms are needed for reselection in the presence of open and hybrid access femto cells.

The application of offsets to measured RSRP has been used to encourage or discourage reselection to specific macro cells as described in 3GPP TS 36.304. Closed subscriber group (CSG) cells (e.g., femto cells defined in 3GPP) are uncoordinated and there can be many such cells, making it difficult to determine appropriate cell specific offsets and to configure them. Broadcasting cell specific offsets for CSG cells also results in too much signaling overhead.

An Intra-frequency reselection indicator as described in 3GPP contribution R2-086648 can be used to prevent a UE from camping on macro cell when the UE is not allowed access to a CSG cell but can cause UL interference to CSG cell. However, this technique does not help if the UE is allowed access to the CSG cell (such as when it is an open or hybrid access CSG cell).

3GPP contribution R1-083195 discusses cell selection based on path loss. This would mean that the UE picks the closest cell. If the UE selects the femto cell, it experiences downlink (DL) interference from the macro cell DL. To overcome the interference R1-083195 further suggests blanking or power reduction in pre-specified time-frequency resources, during which the femto schedules DL for UE. This requires extensive co-ordination between the macro and the femto cells. Another problem with the approach of R1-083195 is that the UE needs to know the transmit power of the CSG cell to determine path loss. This is difficult in an uncoordinated deployment. The lack of an X2 interface at a CSG cell also makes obtaining such information difficult.

3GPP contribution R4-082384 discusses methods to limit interference from a macro cell UE to a CSG cell that the UE is not allowed to access. It proposes a differential path loss threshold to determine when a UE should continue to camp on the macro cell. However, the path loss threshold is specific to the CSG cell and has to be obtained by reading system information of the CSG cell. Reading system information of a cell before reselection is undesirable.

3GPP contribution R2-085124 provides a method for a UE to determine an offset for a CSG cell. However, this requires the UE to know the transmit power of the CSG cell.

The various aspects, features and advantages of the disclosure will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 illustrates a first embodiment.

FIG. 2 illustrates a second embodiment.

FIG. 3 illustrates a third embodiment.

### DETAILED DESCRIPTION

Three embodiments are provided that address the deficiencies in the prior art for reselection in the presence of one or more CSG, e.g., femto, cells, wherein it is assumed that CSG cells have a much smaller max transmit power than macro cells.

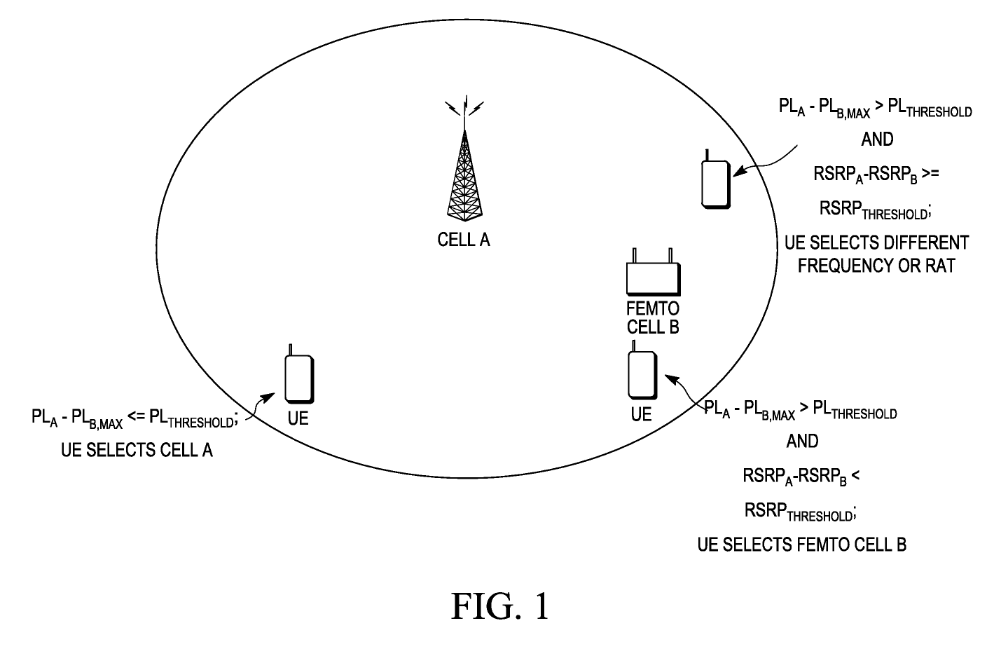

According to a first embodiment illustrated in FIG. 1, assume that the max transmit power of a CSG cell is TxPwr_max. For a given RSRP measurement of a CSG cell, the UE can determine a maximum path loss—PL_max.

Suppose cell A is a macro cell and cell B is a CSG cell in the coverage of A to which the UE is allowed access. Thresholds are used as follows to control the UE's reselection behavior:

If UE's max distance to cell B is much smaller than distance to cell A (i.e., UL transmission to A is likely to impact UL in B) and DL from B is not likely to be overpowered by A, then the UE should select B: If PL_A−PL_B,max>PL_threshold and RSRP_A−RSRP_B<RSRP_threshold, the UE selects cell B.

If the UE's max distance to cell B is much smaller than the distance to cell A and the DL from B is likely to be overpowered by cell A, then the UE attempts to reselect to a different frequency or radio access technology (RAT). If no other frequency or RAT are available, the UE selects A: If PL_A−PL_B,max>PL_threshold and RSRP_A−RSRP_B≧RSRP_threshold, the UE reselects to a different frequency or RAT. Alternatively, in this case, UE can first try to read the system information of cell B and use some information/indication therein to determine whether to reselect to different frequency or RAT.

If neither of the above conditions are satisfied, the UE selects cell A.

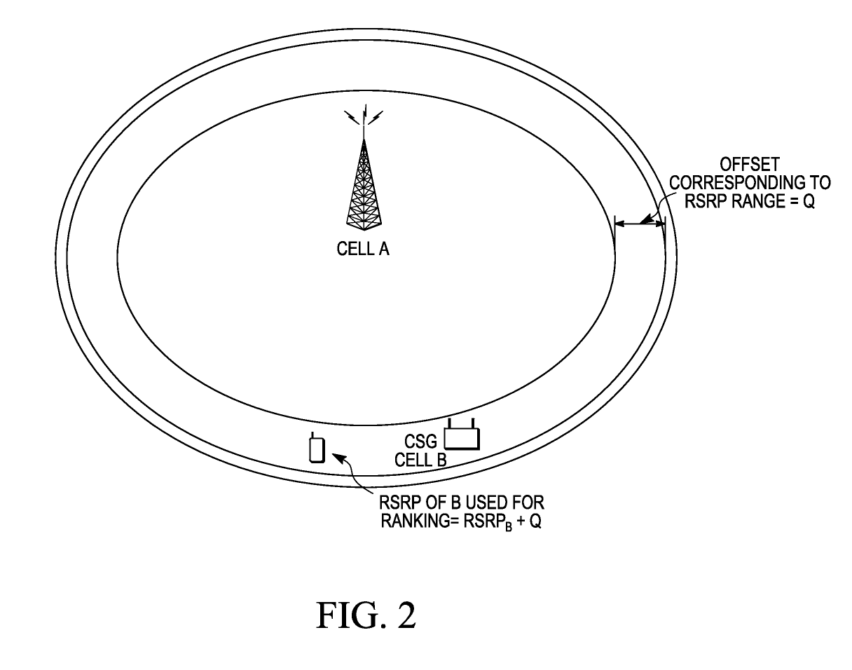

According to a second embodiment illustrated in FIG. 2, a macro cell signals a CSG specific offset for a macro cell RSRP range. The UE applies this offset to the RSRP of the CSG cells before ranking if the macro cell RSRP at the time of measurement of the CSG cell is in the macro cell RSRP range.

This allows the network to control the reselection behavior by (for example): providing a positive offset for a high RSRP range, so that UEs that are close to the macro cell are biased towards the femto cell (to enable the UE to select the femto cell when it is within a nominal coverage area of the femto cell); and providing a negative offset for a low RSRP range, so that UEs that are farther away from the macro cell are biased away from the femto cell (to prevent UE from selecting femto cell when it is outside a nominal coverage area of the femto cell).

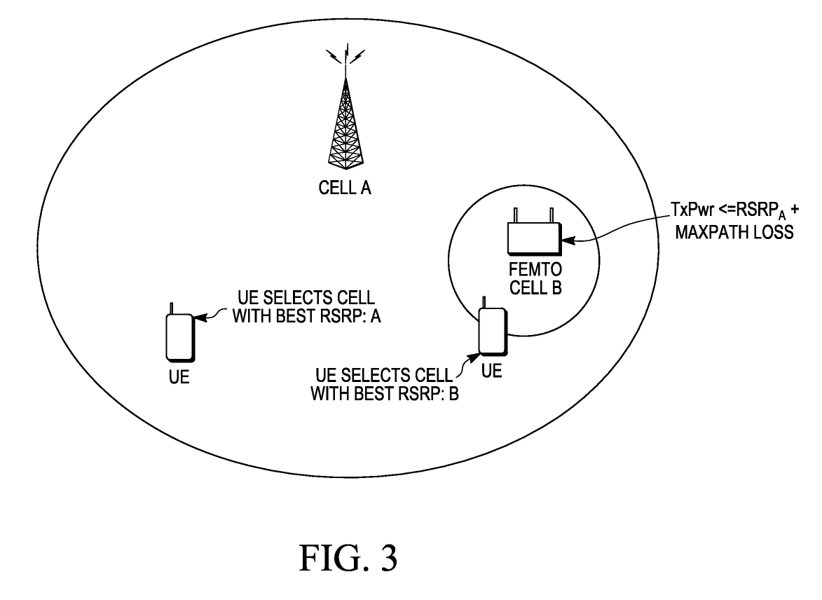

A third embodiment illustrated in FIG. 3, enables reselection based on the best cell principle without the use of any femto cell specific offsets. According to this embodiment, the macro cell transmits a maxPathLoss parameter that applies to femto cells. The maxPathLoss represents the maximum “radius” of the femto cell—i.e., UEs within this radius from the femto cell should select the femto cell.

The femto cell determines RSRP_macro of the macro cell at its location. It sets the transmit power so that TxPwr−maxPathLoss=RSRP_macro. Thus a UE that is within the radius will observe the CSG cell RSRP to be higher than the macro RSRP and select the CSG cell.

This embodiment assumes preferably that the CSG cell has a DL receiver and can measure macro cell RSRP. An alternative to having a DL receiver at the CSG cell is to use a RSRP report of the macro cell from the UE for the RSRP_macro parameter.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a mobile station to perform cell reselection comprising:
receiving a receive power level range and a corresponding receive power level offset from a first cell;
detecting the presence of a second cell;
determining that the receive power level of the signal from the first cell is within the receive power level range;
selecting the second cell when a sum of a receive power level of the signal from the second cell and the receive power level offset is larger than the receive power level of all other cells.

2. The method according to claim 1 further comprising:
determining that the sum of the receive power level of the signal from the second cell and the receive power level offset is smaller than or equal to the receive power level of the first cell, and
selecting the first cell.

3. The method according to claim 1 further comprising:
determining that the receive power level of the signal from the first cell is outside the receive power level range, and
selecting the first cell.

4. The method according to claim 1, wherein the receive power level range comprises a receive power level threshold.

5. The method according to claim 1, wherein the receive power level range comprises a lower bound receive power level threshold and an upper bound receive power level threshold.

6. A method in a base station comprising:
receiving a maximum pathloss parameter,
determining a receive power level of a second base station signal, and
setting the transmit power to no more than the receive power level of the second base station signal plus the maximum pathloss parameter.

7. The method according to claim 6, wherein the receiving a maximum pathloss parameter comprises receiving the maximum pathloss parameter from the second base station.

8. The method according to claim 6, wherein the receiving a maximum pathloss parameter comprises configuring by the network operator the maximum pathloss parameter.

9. The method according to claim 6, wherein the determining a receive power level of a second base station signal comprises measuring the receive power level of the second base station signal.

10. The method according to claim 6, wherein the determining a receive power level of a second base station signal comprises receiving a measurement report from a mobile station that includes the receive power level of the second base station.

11. The method according to claim 6 wherein the maximum pathloss parameter corresponds to the maximum allowable coverage size of the base station.

12. A base station apparatus comprising
a receiver configured to receive a maximum pathloss parameter;
a transceiver configured to communicate with mobile stations;
a controller coupled to the receiver and the transceiver, the controller configured to determine the receive power level of another base station signal; and
the controller further configured to adjust the transmit power to no more than the receive power level of the another base station signal plus the maximum pathloss parameter.

13. The base station apparatus according to claim 12, wherein
the receiver configured to receive a maximum pathloss parameter is further configured to receive a signal from at least the another base station, and is further configured to measure the receive power level of the another base station, and
the controller configured to determine the receive power level of the another base station signal is further configured to obtain the receive power level of the another base station signal from the receiver.

14. The base station apparatus according to claim 12, wherein
the transceiver configured to communicate with mobile stations is further configured to receive from a mobile station receive power level information of the another base station, and
the controller configured to determine the receive power level of another base station signal is further configured to obtain the receive power level from the transceiver.
